(19) United States
(12) Patent Application Publication
(10) Pub. No.: US 2009/0131625 A1
(43) Pub. Date: May 21, 2009

(54) Processes for making elastomeric polyester esters from post-consumer polyester

(76) Inventors: JOSEPH V. KURIAN, HOCKESSIN, DE (US); YUANFENG LIANG, CHADDS FORD, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/944,276

(22) Filed: Nov. 21, 2007

(51) Int. Cl. C08G 63/127

(52) U.S. Cl. 528/176; 528/271; 528/306; 528/279; 528/283

(57) ABSTRACT

Processes for making elastomeric polyether esters from polyesters and polyols are provided. The processes can offer a reduction in manufacturing cost, energy use and a lower environmental footprint than conventional processes, particularly when the processes utilize post-consumer polyesters as starting materials.

### FIELD OF THE INVENTION

The present invention relates to processes for manufacturing elastomeric polyether esters. The processes can use post-consumer polyesters as starting material, and such polyether esters can have attributes and functionality substantially similar to neat or virgin polyether esters.

### BACKGROUND

Polyesters, such as polyethylene terephthalate (PET) and polybutylene terephthalate (PBT) are used in a wide variety of application markets, including fibers, films, and engineering components. Tremendous amount of waste is generated each year from the use of these polyesters that has to be disposed off. Clearly, the disposal creates environmental problems. It would be desirable to re-use these wasted and post-consumed polyesters.

Previous approaches to recycling polyesters have involved the separation and purification of either dimethyl terephthalate (DMT) or terephthalic acid (TPA) from the polyester and a subsequent polycondensation of the DMT or TPA with ethylene glycol. Thus, recycling can become energy intensive, and consequently a prohibitively expensive process.

### SUMMARY OF THE INVENTION

One aspect of the present invention is a process for manufacturing polyether esters from a polyester, comprising contacting said polyester with at least one diol, and at least one polyol, at a temperature in the range of from about room temperature to about 300° C., in the presence of a catalyst.

Another aspect of the present invention is a polyether ester prepared by a process comprising contacting a polyester with at least one diol, and at least one polyol, at a temperature in the range of from about room temperature to about 300° C. in the presence of a catalyst.

### DETAILED DESCRIPTION

In processes according to the present invention, the TPA or DMT separation and purification steps used in conventional processes are eliminated, even when post-consumer polyesters are used as starting materials, lowering the cost of manufacturing. Polymers produced using these processes provide attributes and functionality similar to the virgin polyesters and in preferred embodiments, offer an overall reduction in cost of manufacturing and energy use, lower emissions of greenhouse gases, and therefore, lower environmental footprint. In preferred embodiments, the diol and/or the polyol, used for transesterification of the hard segment and the soft segment in the polyether ester, are derived from bio-based sources.

Unless otherwise defined, all technical and scientific terms, used herein, have the same meaning as commonly understood by one of ordinary skill in the art to which this invention belongs. In case of conflict, the present specification, including definitions, will control.

Unless stated otherwise, all percentages, parts, ratios, etc., are by weight. When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive ‘or’ and not to an exclusive ‘or.’ For example, a condition A or B is satisfied by any one of the following: A is true (or present) and B is false (or not present), A is false (or not present) and B is true (or present), and both A and B are true (or present).

Use of “a” or “an” are employed to describe elements and components of the invention. This is done merely for convenience and to give a general sense of the invention. This description should be read to include one or at least one, and the singular also includes the plural unless it is obvious that it is meant otherwise.

The materials, methods, and examples herein are illustrative only and, except as specifically stated, are not intended to be limiting.

Generally, a process according to the present invention comprises contacting a polyester with at least one diol and at least one polyol at an elevated temperature in presence of a catalyst. The process can offer an overall reduction in manufacturing cost, energy use and can thus offer a reduction in global warming gases and a lower environmental footprint. In some embodiments, the polyester starting material comprises polyester selected from the group consisting of polyethylene terephthalate, polybutylene terephthalate, mixtures thereof, blends thereof and copolymers thereof. In some embodiments, one polyol is used. In other embodiments, at least two polyols are used.

In some embodiments, the present invention provides a process for manufacturing polyether esters from post-consumer polyester, comprising contacting the post-consumer polyester with at least one diol, and at least one oligomeric or polymeric diol (“polyol”), at a temperature in the range of from about room temperature to about 300° C., in the presence of a catalyst, effecting a transesterification reaction. In preferred embodiments, the reaction is carried out in the presence of a catalyst comprising tin or titanium.

In one embodiment, the process provides polyether ester comprising polyethylene terephthalate-based hard segments and polytrimethylene ether glycol (PO3G)-based soft segments from post-consumer polyesters comprising PET, including beverage bottles such as, for example, soda bottles or water bottles, by transesterification reaction of the PET with 1,3-propanediol, preferably a biologically derived 1,3-propanediol (biologically-derived PDO), and PO3G, preferably a biologically derived PO3G. In some preferred embodiments, the post-consumer polyester comprises beverage bottles made from polyester having a recycling code 1, or polyester derived from beverage bottles. In some preferred embodiments, the post-consumer polyester comprises polymeric species selected from the group consisting of polyesters, polyether esters, mixtures thereof, blends thereof, and copolymers thereof.

In some embodiments, a process for manufacturing polyether esters from post-consumer polyester comprises contacting said post-consumer polyester with at least one diol, and at least one polyol, wherein the diol is biologically-derived PDO, and wherein the polyol is PO3G and/or PO4G in the molecular weight range of up to about 5000 Da, at a temperature in the range of from about 200° C. to about 300° C. in the presence of a catalyst comprising tin or titanium, wherein said process utilizes energy less than energy required to make polyester from esterification of diacid or diester with a diol using a polycondensation catalyst.

The polyester used in the process is also referred to herein as “polyester starting material”. Polyesters include, by way of example, thermoplastics commonly known as 2GT, 3GT, 4GT, 5GT, 6GT, 7GT, mixtures thereof, blends thereof, and copolymers thereof. In some embodiments, the polyester starting material comprises polyester selected from the group consisting of polyethylene terephthalate, polybutylene terephthalate, mixtures thereof, blends thereof and copolymers thereof.

In one embodiment, the diol is selected from the group consisting of monomeric, dimeric, or trimeric, C2-C20 alkanediols, alkoxy C2-C20 alkanediol, alkenoxy C2-C20 alkanediol, C2-C20 alkenediol, phenoxy C2-C20 alkanediol, alkylphenoxy C2-C20 alkanediol, phenyl C2-C20 alkanediol, alkylphenyl C2-C20 alkanediol, halo C2-C20 alkanediol, and chemical mixtures thereof; and the polyol is selected from the group consisting of polyols resulting from monomeric, dimeric or trimeric C2-C20 alkanediols, polyalkylene diols, alkoxyalkanediol, alkenoxyalkanediol, alkenediol, glycols, polyether glycol, phenoxyalkanediol, alkylphenoxyalkanediol, phenylalkanediol, alkylphenylalkanediol, haloalkanediol and chemical mixtures thereof. Preferred are diols selected from the group consisting of monomeric, dimeric, or trimeric ethylene glycol 1,3-propanediol, n-butane-1,3-diol, 2-methyl-1,3-propanediol, neopentyl glycol (2,2-dimethyl-1,3-propanediol), 1,4-butanediol, triethylene glycol, isomers thereof and mixtures thereof. In one preferred embodiment, the 1,3-propanediol comprises biologically-derived PDO. Biologically-derived PDO is available from E.I. DuPont de Nemours Company under the tradename Bio-PDOTM.

Also provided is a polyether ester prepared by a process comprising contacting a post-consumer polyester with at least one diol, and at least one polyol, at a temperature in the range of from about room temperature to about 300° C. in the presence of a catalyst comprising tin or titanium. In some embodiments, the catalyst is an organo titanate. In some embodiments, the polyther ester is prepared by a process comprising contacting post-consumer polyether ester comprising polyethylene terephthalate with a diol, and at least one polyol, wherein the diol is biologically-derived PDO, and wherein the polyol is poly(trimethylene glycol) (PO3G) and/or poly(tetramethylene glycol) and/or polypropylene glycol, the diol having a molecular weight of up to about 5000 Da, at a temperature in the range of from about 200° to about 300° C. in the presence of a catalyst comprising tin or titanium, wherein the polyester is at least 80% poly(trimethylene terephthalate) by weight and at most 20% and PET by weight.

The polyether ester can be used to make finished products. Examples include products selected from the group consisting of molded products, monofilaments, and packaging applications, particularly packaging of products for medical applications. In some embodiments the polyether ester has an intrinsic viscosity in the range of from about 0.2 to about 2.0.

### Polyester Starting Material

Polyester starting material includes polyesters as well as thermoplastic elastomers based on polyesters, and including post-consumer polyester. By polyesters is meant polymeric or oligomeric species resulting from condensation reaction (polymerization or oligomerization) of dihydroxy compounds with polybasic acids. Examples are organic dibasic acids having the formula of HOOCACOOH in which A is an alkylene group, an arylene group, alkenylene group. A single type of acid, or combinations of two or more thereof, can be used. Each A has about 2 to about 30, preferably about 3 to about 25, more preferably about 4 to about 20, and most preferably 4 to 15 carbon atoms per group. Examples of suitable acids include, but are not limited to, terephthalic acid, isophthalic acid, phthalic acid, 4,4′-diphenylene dicarboxylic acids, succinic acid, adipic acid, glutaric acid, bibenzoic acid, naphthalic acid, bis(p-carboxyphenyl)methane, 1,5-naphthalene dicarboxylic acid, 2,6-naphthalene dicarboxylic acid, 2,7-naphthalene dicarboxylic acid, 4,4′-sulfonyl dibenzoic acid, p-(hydroxyethoxy)benzoic acid, succinic acid, glutaric acid, adipic acid, sebacic acid, 1,12-dodecane dioic acid. Also suitable are derivatives of such acids, such as the dimethyl, diethyl, or dipropyl esters, and combinations of two or more thereof. The diacid or diester can be aliphatic (including cycloaliphatic) or aromatic, or a combination thereof, and is preferably selected from the group consisting of aromatic dicarboxylic acids and esters (preferably short chain alkyl esters, and more preferably methyl esters), and combinations thereof. Preferred are aliphatic or aromatic diacids, and most preferred are aromatic dicarboxylic acids and combinations thereof. Preferably the aliphatic or aromatic diacid is an aromatic diacid selected from the group consisting of terephthalic acid, isophthalic acid. Of these, terephthalic acid and isophthalic acid, and mixtures thereof are preferred, with terephthalic acid being most preferred.

Preferred polyesters are those resulting from esterification of dimethyl terephthalate, terephthalic acid, or isophthalic acid with diols. Polyesters also include copolyesters having either at least one type of the acid component of the repeat unit and/or at least one type of the diol component in the repeat unit.

Thermoplastic elastomers can be used as starting materials if they are present in post-consumer polyester.

### Post Consumer Polyester

By post-consumer polyester is meant polyester resulting after consumer or industrial use of the polyester. Post-consumer plastic frequently contains suitable polyester starting material for the processes disclosed herein. Exemplary post-consumer polyesters include poly(ethylene terephthalate) (2GT or PET, or PETE), poly(trimethylene terephthalate (PTT), poly(butylene terephthalate) (PBT or 4GT), poly(pentylene terephthalate) (5GT), poly(hexylene terephthalate) (6GT), and poly(heptylene terephthalate) (7GT), and polyether esters such as Hytrel® polymers, mixtures thereof, blends thereof, and copolymers thereof. The bulk of post-consumer polyester or polyester plastic waste consists of poly(ethylene terephthalate) identified by the recycling code 1.

Examples of polyester plastic waste useful for the present processes include recyclable products having a polyester component such as bottles, cups, containers, packaging materials, carpets, textiles, fiber waste, films, engineering components, molded and extruded articles, laminates, coatings, adhesives, etc. Preferred post-consumer polyester includes polyester in the form of beverage bottles such as soda bottles and water bottles.

Post-consumer polyester that can be used in the present processes also includes waste that contains thermoplastic elastomers (TPE) such as segmented copolyesters. Thermoplastic elastomers are a class of polymers which combine the properties of two other classes of polymers, namely thermoplastics, which may be reformed upon heating, and elastomers which are rubber-like polymers. One form of TPE is a block copolymer, usually containing some blocks whose polymer properties usually resemble those of thermoplastics, and some blocks whose properties usually resemble those of elastomers. Those blocks whose properties resemble thermoplastics are often referred to as “hard” segments, while those blocks whose properties resemble elastomers are often referred to as “soft” segments.

Post-consumer polyester starting materials useful in the processes disclosed herein can be made from additional aromatic dicarboxylic acids or diesters such as those disclosed in U.S. Pat. No. 6,562,457, U.S. Pat. No. 6,599,625, and U.S. Pat. No. 7,144,972.

In one preferred embodiment, the post-consumer polyester comprises polyester selected from PET, PBT, 3GT, mixtures thereof, blends thereof and copolymers thereof; the diol is selected from ethylene glycol, propylene glycol, butylene glycol, isomers thereof and combinations thereof; and the polyol is selected from the group consisting of polyols of ethylene glycol, polyols of propylene glycol, polyols of butylene glycol, polyols of isomers thereof, and combinations thereof.

In one embodiment, the post-consumer polyester waste comprises PET, the diol is bio-derived 1,3-propanediol, and the polyol is polytrimethylene glycol. In another embodiment the post-consumer polyester is PET the diol is bio-derived 1,3-propanediol, and the polyol is polytetramethylene glycol. In another embodiment the post-consumer polyester is PBT the diol is bio-derived 1,3-propanediol, and the polyol is polytrimethylene glycol. In another embodiment the post-consumer polyester is PBT the diol is bio-derived 1,3-propanediol, and the polyol is polytetramethylene glycol. In another embodiment the post-consumer polyester is PET and PBT, the diol is bio-derived 1,3-propanediol, and the polyol is polytrimethylene glycol. In preferred embodiment the post-consumer polyester is PET and PBT, the diol is bio-derived 1,3-propanediol, and the polyol is polytetramethylene glycol.

### Diols

In the present processes, polyester is contacted with one or more diols to effect a transesterification reaction. In some embodiments, at least one diol is used. In other embodiments, at least two diols are used.

Exemplary diols useful for the present processes include C2-C20 alkanediols, alkoxy C2-C20 alkanediol, alkenoxy C2-C20 alkanediol, C2-C20 alkenediol, phenoxy C2-C20 alkanediol, alkylphenoxy C2-C20 alkanediol, phenyl C2-C20 alkanediol, alkylphenyl C2-C20 alkanediol, and halo C2-C20 alkanediol. Preferred diols include linear or branched chain C2-C20 alkanediol, for example, ethylene glycol, diethylene glycol, di-, tri- or tetraethylene glycol, di.-, tri- or tetrapropylene glycol and di-, tri- or tetrabutylene glycol, 1,2-propanediol, isopropylene glycol, 1-methyl propylene glycol, 1,3-propanediol, n-butane-1,3-diol, 2-methyl-1,3-propanediol, neopentyl glycol (2,2-dimethyl-1,3-propanediol), 2-methyl-1,3-propanediol, 2,2-diethyl-1,3-propanediol, 2-ethyl-2-(hydroxymethyl)-1,3-propanediol, 1,4-butanediol, triethylene glycol, 1,5-pentanediol, 1,6-hexanediol, 1,2-, 1,3-, and 1,4-cyclohexanedimethanol, 1,7-heptanediol, 1,8-octanediol, 1,9-nonanediol, 1,10-decanediol, 1,12-dodecanediol, 3,3,4,4,5,5-hexafluro-1,5-pentanediol, 2,2,3,3,4,4,5,5-octafluoro-1,6-hexanediol, and 3,3,4,4,5,5,6,6,7,7,8,8,9,9,10,10-hexadecafluoro-1,12-dodecanediol. Also preferred are cycloaliphatic diols, for example 1,4-cyclohexanediol, 1,4-cyclohexanedimethanol and isosorbitol. A highly preferred diol is 1,3-propanediol (PDO).

By 1,3-propanediol is meant a reactant comprising at least one of 1,3-propanediol, 1,3-propanediol dimer and 1,3-propanediol trimer, and includes mixtures thereof. The 1,3-propanediol can be obtained by any of various chemical routes or by biochemical transformation routes known to those skilled in the art. Preferably the PDO has a purity of greater than about 99% by weight as determined by gas chromatographic analysis. Although any combination of PDO, and dimers or trimers of PDO, can be used, it is preferred that the reactant comprise about 90% or more by weight of PDO. More preferably, the PDO reactant comprises 99% or more by weight of PDO.

Particularly preferred is a biologically-derived 1,3-propanediol (bio-derived PDO).

Biochemical routes to PDO have been described that utilize feedstocks produced from biological and renewable resources such as corn feed stock. Such PDO is referred to herein as “biologically-derived PDO” or “bio-derived PDO”. For example, bacterial strains able to convert glycerol into 1,3-propanediol are found in e.g., in the species Klebsiella, Citrobacter, Clostridium, and Lactobacillus. The technique is disclosed in several patents, including, U.S. Pat. No. 5,633,362, U.S. Pat. No. 5,686,276, and, U.S. Pat. No. 5,821,092. In U.S. Pat. No. 5,821,092, Nagarajan, et al. disclose, inter alia, a process for the biological production of 1,3-propanediol from glycerol using recombinant organisms. The process incorporates E. Coli bacteria, transformed with a heterologous pdu diol dehydratase gene, having specificity for 1,2-propanediol. The transformed E. Coli is grown in the presence of glycerol as a carbon source and 1,3-propanediol is isolated from the growth media. Since both bacteria and yeasts can convert glucose (e.g., corn sugar) or other carbohydrates to glycerol, the process of the invention provided a rapid, inexpensive and environmentally responsible source of 1,3-propanediol monomer useful in the production of polyesters, polyethers, and other polymers.

When 1,3-propanediol is used, the 1,3-propanediol may also contain small amounts, preferably no more than about 30%, more preferably no more than about 10%, by weight, based on the total weight of the diols, of comonomer diols in addition to the reactant 1,3-propanediol or its dimers and trimers without detracting from the efficacy of the process. Examples of preferred comonomer diols include ethylene glycol, 2-methyl-1,3-propanediol, 2,2-dimethyl-1,3 propanediol, and C6-C12 diols such as 2,2-diethyl-1,3-propanediol, 2-ethyl-2-hydroxymethyl-1,3-propanediol, 1,6-hexanediol, 1,8-octanediol, 1,10-decanediol, 1,12-dodecanediol, 1,4-cyclohexanediol and 1,4-cyclohexanedimethanol. A more preferred comonomer diol is ethylene glycol.

In one embodiment the processes can be used for converting post-consumer polyester plastic, by reacting such plastic with 1,3-propanediol (PDO such as biologically-derived PDO) and a polyol, in presence of a catalyst under a nitrogen atmosphere at temperatures in the range of about 200° C. to about 300° C. Organo titanate such as Tyzor® TPT can be used as a catalyst for this process.

In another embodiment, the process can be used to convert post-consumer polyester (waste) based on PET, by reacting such polyester with 1,3-propanediol (PDO or biologically-derived PDO) and a polyol, in presence of a catalyst under a nitrogen atmosphere at temperatures in the range of about 200° C. to about 300° C. Organo titanate such as Tyzor® TPT is used as a catalyst for this process. The resulting polymer is a copolyester comprising ethoxy and butoxy repeat units.

### Oligomeric or Polymeric Diols (“Polyols”)

By “polyols” is meant oligomeric diols or polymeric diols. By oligomeric diol is generally meant a species having more than three and up to about twenty repeat units of the same monomeric diol or a combination of comonomeric diols. By polymeric diol is generally meant a species having more than twenty repeat units of the same monomeric diol or a combination of comonomeric diols in the backbone.

In some embodiments of the processes disclosed herein, polyester is contacted with at least one diol and at least one polyol in the presence of a catalyst, at elevated temperature, to produce an elastomeric polyether ester. Generally, the diol in the reaction mixture will contribute to the transesterification for the hard segment of the resulting elastomeric polyether ester and the polyol will contribute to the transesterification for the soft segment of the resulting elastomeric polyether ester.

Diols, including those recited hereinabove, can be converted to polyols in a polycondensation reaction in the presence of polycondensation catalysts. One or more diols can be used to produce such polyols having comonomeric diol-based repeat units. U.S. Pat. No. 6,905,765 describes condensation catalysts that can be used to produce the polyols. They include homogeneous catalysts such as Lewis Acids, Bronsted Acids, super acids, and mixtures thereof. Examples include inorganic acids, organic sulfonic acids, heteropolyacids, and metal salts thereof. Preferred are sulfuric acid, fluorosulfonic acid, phosphorus acid, p-toluenesulfonic acid, benzenesulfonic acid, phosphotungstic acid, phosphomolybdic acid, trifluoromethanesulfonic acid, 1,1,2,2-tetrafluoro-ethanesulfonic acid, 1,1,1,2,3,3-hexafluoropropanesulfonic acid, bismuth triflate, yttrium triflate, ytterbium triflate, neodymium triflate, lanthanum triflate, scandium triflate and zirconium triflate. Heterogeneous catalysts, such as zeolites, fluorinated alumina, acid-treated silica, acid-treated silica-alumina, heteropolyacids and heteropolyacids supported on zirconia, titania, alumina and/or silica, can also be used. Preferred are the aforementioned homogeneous catalysts, and most preferred is sulfuric acid.

Diols from which such polyols can be produced include monomeric, dimeric, trimeric, or oligomeric C2-C20 alkanediols, alkoxy C2-C20 alkanediol, alkenoxy C2-C20 alkanediol, C2-C20 alkenediol, phenoxy C2-C20 alkanediol, alkylphenoxy C2-C20 alkanediol, phenyl C2-C20 alkanediol, alkylphenyl C2-C20 alkanediol, and halo C2-C20 alkanediol.

Further diols from which such polyols can be produced include linear and branched chain monomeric, dimeric, trimeric, or oligomeric C2-C20 alkanediol, for example, ethylene glycol, diethylene glycol, di-, tri- or tetraethylene glycol, di.-, tri- or tetrapropylene glycol and di-, tri- or tetrabutylene glycol, 1,2-propanediol, isopropylene glycol, 1-methyl propylene glycol, 1,3-propanediol, n-butane-1,3-diol, 2-methyl-1,3-propanediol, neopentyl glycol (2,2-dimethyl-1,3-propanediol), 2-methyl-1,3-propanediol, 2,2-diethyl-1,3-propanediol, 2-ethyl-2-(hydroxymethyl)-1,3-propanediol, 1,4-butanediol, triethylene glycol, 1,5-pentanediol, 1,6-hexanediol, 1,2-, 1,3-, and 1,4-cyclohexanedimethanol, 1,7-heptanediol, 1,8-octanediol, 1,9-nonanediol, 1,10-decanediol, 1,12-dodecanediol, 3,3,4,4,5,5-hexafluro-1,5-pentanediol, 2,2,3,3,4,4,5,5-octafluoro-1,6-hexanediol, 3,3,4,4,5,5,6,6,7,7,8,8,9,9,10,10-hexadecafluoro-1,12-dodecanediol, and the longer chain diols and polyols made by the reaction product of diols or polyols with alkylene oxide, and polyethylene glycol 400-4000.

Also useful are cycloaliphatic diols, for example 1,4-cyclohexanediol, 1,4-cyclohexanedimethanol and isosorbitol.

Preferred diols for producing such polyols include monomeric, dimeric, trimeric, or oligomeric ethylene glycol, propylene glycol, and butylene glycol and their isomeric forms. A preferred diol is 1,3-propanediol (PDO). A further preferred diol is a bio-derived 1,3-propanediol (biologically-derived PDO). Preferred polyols are PDO and biologically-derived PDO based-polyols which are oligomeric or polymeric. Such polyols are alternatively called polytrimethylene ether glycols (PO3G).

In a preferred embodiment, when PO3G is used to form the soft segment of the resulting poly ether ester, the soft segment can be represented as comprising units represented by the following structure:

—(OCH2CH2CH2)X—O—CO—R4-CO—

wherein R4 represents a divalent radical remaining after removal of carboxyl functionalities from a dicarboxylic acid equivalent. A wide range of molecular weights of the PO3G can be used. Preferably the PO3G has a number average molecular weight (Mn) of at least about 1,000, more preferably at least about 1,500, and most preferably at least about 2,000. The Mn is preferably less than about 5000, more preferably less than about 4,000, and most preferably less than about 3,500. Therefore, x in the above formula is at least about 17, more preferably at least about 25 and most preferably at least about 34, and is less than about 86, more preferably less than about 67 and most preferably less than about 60. PO3G's useful for this invention are described in U.S. Patent Application Publication Nos. 2002/0007043 A1 and 2002/0010374 A1), and their PCT counterparts WO 01/44348 and 01/44150.

In some embodiments, depending upon what additional polyols or diols are used in the reaction, up to 60 weight % of the soft segment can comprise polymeric ether glycol other than PO3G. Preferred are those selected from the group consisting of polyethylene ether glycol (PEG), polypropylene ether glycol (PPG), polytetramethylene ether glycol (PO4G), polyhexamethylene ether glycol, and copolymers of tetrahydrofuran and 3-alkyl tetrahydrofuran (THF/3MeTHF). The other polymeric ether glycols preferably have a number average molecular weight of at least about 1,000, more preferably at least about 1,500, and preferably up to about 5,000, more preferably up to about 3,500. An especially important copolymer is the copolymer of tetrahydrofuran and 3-methyl tetrahydrofuran (THF/3MeTHF). Preferably up to 55 weight %, more preferably up to 50 weight %, and most preferably up to 15 weight %, of the polyethylene ether glycol used to form the soft segment is PO3G.

Also include are substituted glycols, such as, for example, tetrahydrofuran based polyols are included and methyl-substituted tetrahydrofuran-based polyols.

In another embodiment, polyether ester polymer or copolymer is produced by polycondensation of plastic waste based on PET, by reacting such waste with a mixture of 1,3-propanediol and polytrimethylene glycol in a molecular weight range of about 500 to about 5000. By controlling the ratio of 1,3-propanediol and the PO3G polymer/oligomer, the soft segment content of the resulting polyether ester can also be controlled.

### Catalyst

The processes disclosed herein comprise contacting the post-consumer polyester with at least one diol, for example, 1,3-propanediol, bio-derived, or otherwise, in the presence of a catalyst comprising tin and/or titanium. Any tin-containing compounds that can be used as an esterification catalyst can be used. Generally, the catalyst can be an inorganic tin compound or an organic tin compound. Examples of suitable tin compounds include: n-butylstannoic acid, octylstannoic acid, dimethyltin oxide, dibutyltin oxide, dioctyltin oxide, diphenyltin oxide, tri-n-butyltin acetate, tri-n-butyltin chloride, tri-n-butyltin fluoride, triethyltin chloride, triethyltin bromide, triethyltin acetate, trimethyltin hydroxide, triphenyltin chloride, triphenyltin bromide, triphenyltin acetate, or combinations of two or more thereof. Tin oxide catalysts are preferred. Suitable tin compounds are generally commercially available. For example, n-butylstannoic acid can be obtained from the Witco Chemical Corp., Greenwich, Conn.

Preferred titanium compounds are organic titanium compounds, in particular, titanium tetrahydrocarbyloxides, also referred to as tetraalkyl titanates. Examples of suitable titanium tetrahydrocarbyloxide compounds include those expressed by the general formula Ti(OR)4 where each R is individually selected from an alkyl or aryl radical containing from 1 to about 30, preferably 2 to about 18, and most preferably 2 to 12 carbon atoms per radical and each R can be the same or different. Titanium tetrahydrocarbyloxides in which the hydrocarboxyl group contains from 2 to about 12 carbon atoms per radical which is a linear or branched alkyl radical are most preferred because they are relatively inexpensive, more readily available, and effective in forming the solution. Suitable titanium tetrahydrocarbyloxides include, but are not limited to, titanium tetraethoxide, titanium tetrapropoxide, titanium tetraisopropoxide, titanium tetra-n-butoxide, titanium tetrahexoxide, titanium tetra 2-ethylhexoxide, titanium tetraoctoxide, and combinations of two or more thereof. The titanium tetrahydrocarbyloxides can be produced by, for example, mixing titanium tetrachloride and an alcohol in the presence of a base, such as ammonia, to form the titanium tetracarbyloxide or tetraalkyl titanate. The alcohol can be ethanol, n-propanol, isopropanol, n-butanol, or isobutanol. Titanium tetrahydrocarbyloxides thus produced can be recovered by first removing by-product ammonium chloride by any means known to one skilled in the art such as filtration followed by distilling the titanium tetrahydrocarbyloxides from the reaction mixture. This process can be carried out at a temperature in the range of from about 0 to about 150° C. Titanates having longer alkyl groups can also be produced by transesterification of those having R groups up to C4 with alcohols having more than 4 carbon atoms per molecule.

Examples of commercially available organic titanium compounds include TYZOR®TPT and TYZOR®TBT (tetra isopropyl titanate and tetra n-butyl titanate, respectively) available from E. I. du Pont de Nemours and Company, Wilmington, Del., U.S.A.

If both tin and titanium are used, the weight ratio of the tin compound to the titanium compound can be any ratio provided that the ratio can catalyze the esterification of an acid and 1,3-propanediol. Generally, the ratio can be about 0.01:1 to about 100:1 and preferably about 0.1:1 to about 10:1.

The catalyst can be prepared by any method known to one skilled in the art. For example, the catalyst can be produced by separately combining the tin compound or titanium compound with the acid or 1,3-propanediol in an esterification medium, or in situ in an esterification medium by combining the tin compound or titanium compound with the acid, 1,3-propanediol, or both.

Preferably, the catalyst is produced before the contacting with the esterification medium. Thus, it is preferred that a premixed catalyst comprising, consisting essentially of, or consisting of the tin compound and the titanium compound be produced before being contacted with the esterification medium. More preferably, the tin and/or titanium catalysts are mixed in an organic solvent before adding to the reactants. Any solvent that can substantially dissolve or disperse the catalyst and does not interfere with polymerization can be used. For convenience, the organic solvent can be 1,3-propanediol.

Preferably, the amount of tin used as catalyst is between about 2 and 400 ppm and the amount of titanium used as catalyst is between about 2 and 400 ppm, each elemental amount based on the weight of reactants in the esterification medium.

The process can allow control of the ratio of the acid repeat units to the alkoxy repeat units and the ratio of soft segments to hard segments in the elastomeric polyether ester made by the process, by controlling the initial molar ratio of the diol, polyol, and the polyester. In a preferred embodiment, the mole ratio is in the range of from about 100:1 to about 1:1 of (diol+polyol) to polyester (or to the amount of polyester in the post-consumer polyester when other components such as waste are present). In a further preferred embodiment, the molar ratio of diol to polyol is from about 100:1 to about 1:100. A preferred mole ratio of (diol+polyol) to polyester is in the range of 5:1 to about 1:1.

The transesterification can be affected in a preferred temperature range of from about 200° C. to about 300° C. The temperature can, if desired, be maintained at one point for the entire reaction. Alternatively, the temperature can be maintained for different or same periods of time at more than one temperature points, and the temperature varied once or more than once.

In preparing the polyether ester elastomers, it is sometimes desirable to incorporate known branching agents to increase melt strength. Such agents are incorporated added to the reaction mixture before transesterification. In such instances, a branching agent is typically used in a concentration of 0.00015 to 0.005 equivalents per 100 grams of polymer. The branching agent can be a polyol having 3-6 hydroxyl groups, a polycarboxylic acid having 3 or 4 carboxyl groups, or a hydroxy acid having a total of 3-6 hydroxyl and carboxyl groups. Representative polyol branching agents include glycerol, sorbitol, pentaerythritol, 1,1,4,4-tetrakis(hydroxymethyl)cyclohexane, trimethylol propane, and 1,2,6-hexane triol. Suitable polycarboxylic acid branching agents include hemimellitic, trimellitic, trimesic pyromellitic, 1,1,2,2-ethanetetracarboxylic, 1,1,2-ethanetricarboxylic, 1,3,5-pentanetricarboxylic, 1,2,3,4-cyclopentanetetracarboxylic and like acids. Although the acids can be used as is, it is preferred to use them in the form of their lower alkyl esters. Conventional additives can be incorporated into the polyester product by addition during esterification. The additives include delusterants (e.g., TiO2, zinc sulfide or zinc oxide), colorants (e.g., dyes), stabilizers (e.g., antioxidants, ultraviolet light stabilizers, heat stabilizers, etc.), fillers, flame retardants, pigments, antimicrobial agents, antistatic agents, optical brightners, extenders, processing aids, viscosity boosters, and other functional additives.

The polyesters made by the processes disclosed herein can be used in all applications in which polyesters obtained from esterification of a diacid or diester with a diol. For example, the polyester made by the processes can be used as fibers in all fiber applications such as apparels, textiles, carpets, cords, tire components, woven materials, nonwoven materials, packaging materials, engineering applications such as molded parts, extruded parts, laminated parts, insulation, electrical insulation, automotive parts, exterior and interior building components, bottles, and containers.

### EXAMPLES

### Example 1

### Renewably Resourced Elastomeric Polyether Ester Polymer from PET

A 250 ml, three-necked flask was charged with 30 g of PET-3934 (obtained from E. I. du Pont de Nemours & Co., Wilmington, Del.), 31 g of bio-PDO (for a PDO:PET polymer mole ratio of about 3:1) (obtained from E. I. du Pont de Nemours & Co., Wilmington, Del.), and 38.4 g of poly(trimethylene glycol) (obtained from E. I. du Pont de Nemours & Co., Wilmington, Del.) with a molecular weight of 1700 Da (for an estimated polyol soft segment content of about 60% wt in the final polymer). Tyzor® TPT (36 mg) was added as catalyst to the polymerization mixture. The temperature of the reactant mixture in the flask was raised gradually to 240° C. with the reaction mixture under a nitrogen environment. The temperature was held at 240° C. for about 1 hour. Temperature was further raised to 250° C. and held at 250° C. under a vacuum of 0.2 mm (2.66×10-5 MPa) for 2 hrs. At the end of the reaction, the flask was cooled and polymer was collected.

The resulting polymer had a melting point of 190.4° C., and IV of 0.92 dL/g. The PET content by NMR analysis was 1.5% by weight.

### Example 2

### Renewably Resourced Elastomeric Polyether Ester Polymer from PET and PBT Mixture

A 250 ml three-necked flask was charged with 16 g of PET 3934, 16 g of PBT (obtained from E. I. du Pont de Nemours & Co., Wilmington, Del.), 35 g of bio-PDO for a mole ratio of PDO : (PET+PBT) polymer of 3: 1, and 32 g of poly(trimethylene glycol) with a MW of 500 Da (for an estimated polyol soft segment content of 50% wt in the final polymer). Tyzor® TPT (36 mg) was added as catalyst to the polymerization mixture. The temperature of the reactant mixture in the flask was raised gradually to 230° C. under a nitrogen environment. The temperature was held at 230° C. for 1 hour. The temperature was further raised to 250° C. and held at 250° C. under a vacuum of 0.2 mm (2.66×10-5 MPa) for 2 hrs. At the end of the reaction, the flask was cooled and polymer was collected.

The resulting polymer had a melting point of 120° C., and IV of 0.6 dL/g. The PET content was 8.6% by weight and PBT content was 4.9% by weight by NMR analysis.

1. A process for manufacturing polyether esters from a polyester, consisting of contacting said polyester with at least one diol, and at least one polyol, at a temperature in the range of from about room temperature to about 300° C., in the presence of a catalyst.

2. The process of claim 1, wherein said polyester is a post-consumer polyester.

3. The process of claim 2, wherein said post-consumer polyester comprises beverage bottles made from polyester.

4. The process of claim 3, wherein said beverage bottles are made from polyester with a recycling code 1.

5. The process of claim 2, wherein said post-consumer polyester comprises one or more polymeric species selected from the group consisting of poly(ethylene terephthalate), poly(trimethylene terephthalate), poly(butylene terephthalate), poly(pentylene terephthalate), poly(hexylene terephthalate), poly(heptylene terephthalate), polyether esters, mixtures thereof, blends thereof, and copolymers thereof.

6. The process as recited in claim 1, wherein the diol is selected from the group consisting of monomeric, dimeric, or trimeric, C2-C20 alkanediols, alkoxy C2-C20 alkanediol, alkenoxy C2-C20 alkanediol, C2-C20 alkenediol, phenoxy C2-C20 alkanediol, alkylphenoxy C2-C20 alkanediol, phenyl C2-C20 alkanediol, alkylphenyl C2-C20 alkanediol, halo C2-C20 alkanediol, and chemical mixtures thereof; and the polyol is selected from the group consisting of polyols resulting from monomeric, dimeric or trimeric C2-C20 alkanediols, polyalkylene diols, alkoxyalkanediol, alkenoxyalkanediol, alkenediol, glycols, polyether glycol, phenoxyalkanediol, alkylphenoxyalkanediol, phenylalkanediol, alkylphenylalkanediol, haloalkanediol and mixtures thereof.

7. The process as recited in claim 6, wherein the diol is selected from the group consisting of monomeric, dimeric, or trimeric ethylene glycol, 1,3-propanediol, n-butane-1,3-diol, 2-methyl-1,3-propanediol, neopentyl glycol (2,2-dimethyl-1,3-propanediol), 1,4-butanediol, triethylene glycol, isomers thereof and mixtures thereof.

8. The process as recited in claim 7, wherein said 1,3-propanediol is biologically derived.

9. The process as recited in claim 1, wherein the polyol is selected from polyols resulting from the polymerization of a member of the group consisting of ethylene glycol, 1,3-propanediol, 1,2-propanediol, 1,4-butanediol, 1,2-butanediol, 1,3-butanediol, and mixtures thereof.

10. The process of claim 1, wherein said catalyst comprises tin or titanium.

11. The process of claim 10 wherein said catalyst is an organo titanate.

12. A polyether ester prepared by a process consisting of contacting a polyester with at least one diol, and at least one polyol, at a temperature in the range of from about room temperature to about 300° C. in the presence of a catalyst.

13. The polyether ester of claim 12 wherein said polyester is a post-consumer polyester.

14. The polyether ester of claim 12 wherein said post-consumer polyester comprises beverage bottles made from polyester.

15. The polyether ester of claim 12 wherein said beverage bottles are made from a polyester having a recycling code 1.

16. The polyether ester of claim 12 wherein the catalyst comprises tin or titanium.

17. The polyether ester of claim 12, wherein at least one diol comprises biologically-derived 1,3-propanediol, and wherein at least one polyol is selected from poly(trimethylene glycol), poly(tetramethylene glycol), and polypropylene glycol, said polyol having a molecular weight up to about 5000 Da, at a temperature in the range of from room temperature to about 300° C.

18. The polyether ester of claim 12 wherein the diol is biologically-derived 1,3-propanediol.

19. A finished product made from a polyether ester of claim 12, said product selected from the group consisting of monofilaments, molded products and packaging.

20. The polyether ester of claim 12, wherein said polyether ester has an intrinsic viscosity in the range of from about 0.2 to about 2.0.

21. The polyether ester of claim 12, wherein said polyether ester has a melting temperature in the range of 80° C to 240° C.
